(19) United States
(12) Patent Application Publication
(10) Pub. No.: US 2004/0225563 A1
(43) Pub. Date: Nov. 11, 2004

(54) System and method for a bonus store credit program

(76) Inventor: Tabbatha Lawe, Chapel Hill, NC (US)

Correspondence Address: ALUN L. PALMER, PATENT AGENT, 4300 PINEY CHURCH ROAD, WALDORF, MD, 20602, US

(21) Appl. No.: 10/755,847

(22) Filed: Jan. 13, 2004

Related U.S. Application Data
(60) Provisional application No. 60/439,646, filed on Jan. 13, 2003.

(51) Int. Cl. G06F 17/60

(52) U.S. Cl. 705/14; 705/26

(57) ABSTRACT

Automatic creation of bonus store credit by validating a transaction to determine any credit owed to the buyer and using that credit in a second transaction with the seller. A seller registers as a provider of bonus store credit and receives text to display on their selling page. When a transaction closes, the system is notified, captures relevant data from the notification and from the selling page, and qualifies a credit amount, by meeting or exceeding fixed price or minimum bid levels described on the selling page. The buyer receives a notification of any qualified credit amount. Update notifications to the buyer via electronic messages remind her of her open credit and promote the seller's other offerings by additional links to other listings. The system recognizes any second transaction occurring between the buyer and seller and validates it as eligible for the application of the credit.

### BACKGROUND OF THE INVENTION

1. Field of the Invention

This invention relates generally to systems and methods for enhancing retail sales. This invention is particularly well suited for auctions or fixed price purchases executed at a market venue web site over networks including the Internet.

2. Discussion of the Background

Online sales, like those generally conducted at eBay, Amazon and other such market venues, are heavily populated and utilized by individuals selling only one product at a time. However, there is another group of sellers, known generally as “power sellers,” who sell multiple items through multiple auctions over the course of a year. These power sellers are small in relative numbers with one estimate saying 4% of all eBay sellers qualify as power sellers. Yet, these 4% of sellers are understood to account for over 80% of gross merchandise sales on eBay.

Generally, these power sellers are small entities without sophisticated marketing systems or skills Thus, they do not readily cross-sell items outside their market venue presence or provide appropriate customer loyalty programs for their buyers. For instance, many do not consistently utilize email marketing programs to cross-sell products to their known buyer list. Instead, they rely solely on the draw of the market venue web site to attract customers who will return again and again to the market venue, presumably to buy the seller's goods. However, as the market venue draws a greater number of potential buyers more sellers with more listings also join. Thus, each seller is sacrificing their ability to distinguish themselves to new or repeat buyers as the market venue grows.

Additionally, most auction sites also offer their sellers the option to list products at a fixed price, which if selected by the buyer, immediately closes an auction out. The draw for a fixed price sale over conducting an auction is threefold. Firstly, the transaction time is faster. Secondly, buying at a fixed price is more productive for both buyer and seller. And thirdly, cash collections can help speed up the seller's revenue time.

In most cases, auctions will run for 7-10 days. In a fixed price sale a transaction closes almost immediately. Without a fixed price option, if a bidder wants to purchase a product they would normally be forced to continue to participate in the auction for the duration—which is unproductive for them, and exposes them to losing the auction to a last minute bidder. Likewise, the seller has to hold merchandise in inventory for that same period reducing their annual inventory turnover and increasing their costs to carry the inventory. All this occurs even though the seller and buyer are both ready to commit to a sale.

Furthermore, unlike fixed price sales, auction sales subject the seller's revenue to unknown variables and fluctuations. At the conclusion of the auction, the final winning bid might be lower than the seller wished for, but the seller is still generally obligated to fulfill the bidder's order at that lower price. Sellers would eagerly trade off this variability if they could consistently see higher bid prices, but that is not easily assured.

Thus, rewarding or encouraging buyers to utilize the fixed price buying option in lieu of the auction, or encouraging them to bid higher than they normally would is highly beneficial for the seller. However, market reports indicate that buyers select the fixed price option only 20% of the time. A method that entices the buyer to utilize the fixed buying option or any method which encourages higher bidding is beneficial for the seller.

The reason that buyers do not more frequently select to purchase using the fixed price buying option is founded in the buyer's belief that by choosing to bid the buyer MIGHT ultimately receive a lower price than by buying at a fixed price. Sellers are also in need of a ready-made means for the sellers to promote additional sales to the buyer. But the seller is leery of any marketing effort that draws buyers to the market venue, rather than directly to their listings since the seller is competing heavily with other sellers on the market venue.

An additional element of background art for consideration is the effectiveness of cross-selling products. Each auction or fixed price sale provides the seller with the name of a “hot buyer.” A hot buyer is considered by direct marketers to be the most advantageous source of potential additional sales. By making the first purchase from the seller, the buyer signals several things to the seller. Firstly and most obviously, they signal that they are in the market buying products—and especially products in the same category as the original purchase. Secondly, they signal that they are comfortable buying from the seller. This trust signal is important because it provides the seller with confidence that the buyer will buy again. Finally, the buyer is signaling a price point where they are comfortable buying.

The seller needs to capitalize on these signals by creating a cross promotional program for the buyer. The seller wants to provide a reason for the buyer to consider the cross promotion. The cross promotion content can simply be an update on the seller's other auction sales or can be a direct solicitation to purchase a product. For example, the seller should cross-sell additional collectible dolls to a known doll buyer, at a price range within the same level as the first product and coming with a special invitation from the same seller, or simply send an email with a listing of the seller's other auctions.

While email is very attractive as a tool to cross-sell products, a 1999 study from researchers at the University of California, Berkley estimated that 500 to 600 Billion email messages would be sent worldwide in 2000. Forrester Research predicts that the average household will receive nine pieces of marketing email per day by 2004. This volume of email encounters consumer resistance. In fact, today's huge volume of email has already been followed by a consumer backlash in the form of flame email. Flame email consists of angry emails sent by recipients of unsolicited commercial email UCE (also known as spam) to the offending sender's email box.

In light of the exponentially expanding emails being sent by companies, email recipients are also resorting to using intelligent software programs to scan their incoming email messages to identify only those messages worth reading. Those skilled in the art will recognize that offers from a seller to cross promote other products will generally not be considered compelling by most recipients. Therefore, sellers are searching for compelling reasons to send consumers email messages which they will accept and read, and which will provide the retailer with the opportunity to sell more products. Heretofore, companies have tried to create compelling value by combining email product offers with newsletter copy with some perceived value in the editorial.

### SUMMARY OF THE INVENTION

Accordingly, embodiments of the invention include provide market venue sellers with a simple, customizable way for each seller to promote a bonus store credit to their potential buyers. The seller's proposal for a specific bonus store credit encourages the buyer to raise their bid based on a promise for store credit based on the final winning price point or to purchase a product at a fixed price immediately by creating an incentive for the buyer by offering an attractive offsetting store credit at the fixed price level. Likewise, the potential for receiving a bonus store credit after purchase, either by using a fixed price or with a highest bid, reduces the buyer's fear of overpaying by creating an offsetting store credit if they make such a purchase. The presence of a bonus store credit provides the buyer with compelling reasons to respond to cross promotional offers from the buyer. Additionally, by providing for seller customization of the bonus store credit, the seller is also able to greatly differentiate themselves from other sellers offering like products.

Embodiments of the invention operates on the premise that the seller has the obligation to fulfill the bonus store credit directly with the buyer. Since the bonus store credit is held by a specific seller for a specific buyer and is non-transferable, the seller is assured that the buyer can only exercise the store credit through a second purchase with the seller. This is advantageous for the seller. Likewise, by holding an open bonus store credit, the buyer has a greater incentive to make a second purchase from the seller then if no bonus store credit existed. In effect, the buyer's bonus store credit will effectively lower the purchase price of the second sale. Thus, the bonus store credit provides an additional reason for the buyer to want to re-visit the seller's listings at the market venue for second product consideration.

Moreover, a preferred embodiment of the invention enables the seller's bonus store credit proposal by the seller to be presented to the buyer in the form of specific displayed instructions. The specific instructions specify precise rules by which the bonus store credit is to be determined, so as to reduce the possibility of dispute between the seller and the buyer. However, the displayed instructions can be customized by the seller to include seller selected monetary thresholds. Thus, the seller has complete control over thresholds set for granting a bonus store credit. Likewise, by reading the displayed instructions, the buyer can easily calculate what, if any, extra value they get from the expected bonus store credit at the given threshold.

To encourage a second purchase by the same buyer, the invention also serves to promote the seller's future listings to the buyer by automatically reminding the buyer of his/her bonus store credit amount while including a list of the seller's currently offered products or services for sale in the same reminder notice. The reminder comes in the form of one or more electronic mail messages. Such email messages are inexpensive to compose and deliver.

Such messages will have a high perceived value to the buyer because they offer a reminder of the bonus store credit. Further, by including the seller's listings, for example as embedded html links within the body of the reminder emails, the system creates immediate access for the buyer to the seller's other product listings making a second sale more likely.

The bonus store credit system is particularly advantageous for use over the Internet facilitating transactions occurring between a seller and a buyer at a market venue such as eBay, Amazon or Yahoo. However, the bonus store credit system described can also be used from within a centrally managed market venue.

The preferred embodiments of the present invention provide systems and methods for enabling an auction or fixed-price seller, referred to herein as the “seller,” to engage with their customers, referred herein as the “buyer”, in a bonus store credit system which automatically administers a bonus store credit program by facilitating the creation of the bonus store credit and by validating to both parties any bonus store credit owed by the seller to the buyer. The program further reminds the buyer of the store credit and promotes other listings where the store credit can be used by the buyer in a second transaction. The program further validates the applicability of the bonus store credit in a second transaction between the buyer and the seller at a market venue.

This system and method preferably includes a bonus store credit registration by the seller, the proposal of the bonus store credit program by the seller to the buyer at the point of sale by specific displayed instructions explaining how the bonus store credit is calculated and administered, the creation and sending of update email messages to the buyer showing the open store credit and listing other seller items for sale, and a subsequent confirmation of the validity and availability of the bonus store credit in a second transaction between the buyer and the seller.

This system enables the buyer and seller to efficiently and profitably create, track and subsequently execute the bonus store credit on a second purchase. The bonus store credit is owed by the seller to the buyer and the system primarily acts as the facilitator to manage information regarding the bonus store credit program on behalf of the buyer and seller.

A preferred embodiment of this invention profitably allows the seller to manage a bonus store credit program where the store credit is given as a bonus to a buyer who purchases at a certain fixed price or at various bid levels as proposed by the seller at a market venue.

A preferred embodiment of the invention also offers the buyer periodic updates of the buyer's open bonus store credit amount. These periodic updates provide the seller with opportunities to cross-sell other products to the buyer.

In a preferred embodiment of the invention, bonus store credit registration by the seller begins the bonus store credit program. In order to register the seller accesses a registration software program on a web server through which the seller can initiate their bonus store credit program.

The seller preferably initiates the bonus store credit program by entering information in HTML forms within a bonus store credit web site. The bonus store credit web site would include a web server computer running a web server software application serving web pages. Web sites may, for example, be provided over the Internet, an intranet, an extranet or any TCP/IP network. HTML forms transfer data as either a ‘POST’ or ‘GET’ operation in the Hyper Text Transfer Protocol (HTTP), as is known to those skilled in the art. Once the seller establishes his/her bonus store credit program, the seller is given access to and approval to use specific displayed instructions regarding the bonus store credit on the seller's web selling page.

The seller is preferably instructed to copy the displayed instructions and customize the displayed instructions by entering specific monetary values within specific fields in the body copy of the displayed instructions. Alternatively, the seller can enter their specific monetary values during registration and the web site system can host the image for the seller. In this scenario, the seller posts HTML code on their selling page, and an image representing their unique store credit offer is called from the system as the displayed text.

The displayed instructions including the seller's customized entries can be advantageously employed to create a set of instructions which adequately describe the bonus store credit program to the buyer. The seller can present these displayed instructions on their product selling page at the market venue to provide the buyer with adequate disclosure of the bonus store credit parameters during the sale process.

Next, the system waits until it receives notification indicating that a fixed-price or auction transaction has closed between the registered seller and a buyer at the market venue. The notification requires the auction ID number, but optimally includes the seller's ID and email address, the buyer's email address, method of sale (fixed price or auction), item price paid, item ID number, web address of the selling page and date of the transaction.

In a preferred embodiment of the invention the notification is received by having the seller forward the close of transaction email, originally generated by the market venue web site, to the bonus store credit system. The notification could also be sent via HTTP transfer, as will be understood by those skilled in the art. The close of transaction email is also referred to as the end-of-auction email. Advantageously, the bonus store credit system can access this same information from the market venue web site through an approved application programming interface.

Upon receipt of the transaction information described above, the system automatically polls the web selling page at the market venue web site directly to capture relevant data not captured from the notification and to capture the displayed instructions from the closed listing web selling page. In a preferred embodiment of the invention, this process occurs in what is called a web screen scrape and involves the bonus store credit system directing the electronic capture of defined text from the web selling page address which was identified in the end-of-auction email.

The system then stores the captured data and parses the captured selling web page text elements into appropriate database fields in the system for subsequent analysis and action. For example, the system captures the text area describing the amount of bonus store credit to be credited if the sale occurred as a fixed price transaction. It also captures the formula to use in calculating the bonus store credit as well as the minimum threshold set by the seller for bonus store credit to be awarded in an auction sale and the length of time the store credit will be valid. Each of these elements are parsed and entered into a database.

In a preferred embodiment of the invention, the displayed instructions will explain to the buyer that different winning bid amounts will qualify for a specific bonus store credit.

Sellers can choose to offer four different versions of displayed instructions: for auction and fixed price sales, for auction only sales, for standard price points or for fixed price only sales.

For example, a seller proposing a bonus store credit in both an auction and fixed price sale could display instructions as follows:

“MyStoreCredit: As a BONUS, if you purchase using Buy It Now I will automatically give you a future store credit of $2.00. Likewise, if you bid at least $42.00 and win, I will give you a future store credit of $2.50 plus any amount you bid over $42.00 (up to $10). I'll apply this store credit just like cash when you purchase goods in any of my other auctions for the next 12 months.

The bonus store credit will be valid upon your receipt of a validation email from Mystorecredit.com, an independent third party market venue payment/mediation service who will administer this bonus store credit program for me. Mystorecredit.com will also remind vou of your store credit by email throughout the year so you won't lose track of it. This bonus store credit is non-transferable and can only be applied to purchases from my other listings unless expressly excluded.”

In this example, the system would capture the body of text above during the screen scrape. It would next parse the text into fields used to calculate the bonus store credit. For example, if the end-of-auction email indicated that the closed transaction was a fixed price sale (executed with “Buy It Now”) the system would create a bonus store credit entry in a database for $2.00. Alternatively, if the system determined that the sale was an auction sale, it would next determine whether the final winning bid in the end-of-auction email exceed $42.00. If so, it would subtract $42.00 from the final winning bid and add $2.50 to that figure. Where this figure was less than $10.00, it would be entered as the bonus store credit in the database. If the result was more than $10.00, then $10.00 would be entered as the bonus store credit. In all other cases, the system would create a $0.00 bonus store credit entry for the transaction identified in the end-of-auction email

Alternatively, a seller could propose a universal bonus store credit amount for every auction. A universal store credit amount would be offered for every sale, and the seller would set store credit amounts based on various final winning bid threshold levels. In this embodiment, store credit would be offered without regard to the lower price or fixed priced option. In this case, the displayed instructions would appear as follows:

“To thank all my buyers for their business and to invite you to return and buy with me again, I will give you a future store credit as a bonus with every final sale. I will automatically apply this store credit whenever you purchase from any of my other eBay auctions over the next 12 months by including a rebate check in your next shipment.”

In this example, the seller would cause their universal bonus store credit displayed text to be displayed to the buyer on the selling page by pasting the universal bonus store credit displayed text onto their selling page, by pasting the universal bonus store credit displayed text as a picture image on the selling page, or by causing the selling page to call the image from the store credit web site by the seller pasting specific HTML language on the selling page. In all cases, the seller's unique universal bonus store credit displayed text offer would be used by the system to calculate the bonus store credit created for the buyer. The system would determine the final winning bid amount and identify the store credit amount to create for the buyer based on comparing the winning bid amount to the universal bonus store credit displayed text. For example, if the seller had indicated that any buyer with a winning bid between $25.00 and $44.99 should receive a $3.00 store credit, the system would create a store credit for that amount if the buyer's purchase prices was between $25.00 and $44.99.

Once a bonus store credit amount greater than zero is calculated, the system advantageously sends an email to the buyer confirming the open store credit amount, and opens a personal web portal for the buyer. Both include relevant data regarding the bonus store credit transaction, such as the buyer's email address, the bonus store credit amount, a seller ID code and a bonus store credit ID code. As a regular part of its operations the bonus store credit system posts appropriate bonus store credit information updates to a seller specific data file which can also be accessed and displayed using a seller's portal page or can be emailed in report format to the seller.

Thereafter the bonus store credit system performs searches of the market venue site periodically using its polling software to find existing auction listings being run by the seller. It captures, or records links to, these existing listings for inclusion in emails to the buyer. In preferred embodiments of the invention, in performing searches, the system uses a screen scrape process similar to that mentioned earlier or interfaces directly with the market venue through a program using the application programming interface provided by the market venue.

After capturing the seller's listings, the system then prepares a message for delivery to the buyer to confirm the open bonus store credit to the buyer and to simultaneously update the buyer on the availability of the auctions being run by the seller where the bonus store credit can be applied like cash. The messages would preferably be in the form of email, but alternatively could be electronic messages sent to customer's mobile phones, fax machines, pagers, or voice mail boxes, or could be messages displayed to the buyer on the web pages of a market venue or sent by regular postal mail. The emails would be composed by the bonus store credit system and could contain the open bonus store credit amount and information relating to the seller's open listing or may include specific second offers to the buyer.

In a preferred embodiment of the invention, the emails contain hypertext links to pages including the seller's open listings. These links make accessing the available auctions as simple as possible for the buyer. The links are presented as titles to the seller's listings.

When a buyer subsequently chooses to purchase again from the seller through either a fixed price option or through successful bidding, hereinafter referred to as a second transaction, the buyer can be expected to use their bonus store credit in the second transaction as a cash equivalent. The buyer completes the second transaction as they would with any other transaction at the market venue.

Next, at the close of the second transaction when the seller causes the forwarding of the end-of-auction email to the bonus store credit system, the bonus store credit system automatically checks the bonus store credit file to see if the pair of buyer and seller ID's listed in the end-of-auction email hold an existing open bonus store credit amount. If yes, the system will automatically validate the open store credit amount and remind the seller and buyer by email of the availability of the open credit amount and propose that the open bonus store credit be deducted from the final payment by the buyer. After such notification, the buyer can then submit payment less the open bonus store credit and the seller can accept the item purchase price less the bonus store credit number as payment in full for the second transaction. Alternatively, the seller can send the buyer cash for the amount of the applied store credit.

After the system validates the second transaction and notifies the buyer and seller, the system places a hold on the open bonus store credit held between the buyer and seller by updating the store credit database file. The hold prevents a re-issuing of the open credit for any other transaction between the buyer and seller. The seller is expected to periodically return to the bonus store credit site to close out all held bonus store credits and the seller can also otherwise modify bonus store credit records as needed through a web interface provided for that purpose. When a modification is made to a bonus store credit record by the seller the system may, based on the nature of the change, confirm the change to the buyer and seller via an email.

Alternatively, the invention allows the buyer to notify the seller and the bonus store credit system within a fixed period of time after the second purchase transaction that the buyer intends to apply the open bonus store credit as a cash equivalent payment to the second purchase. Upon receipt of this email notification from the buyer, the bonus store credit system parses the buyer's email into individual data elements. For example, it searches the email for the buyer's email address, the bonus store credit amount, the seller's ID, the original bonus store credit identification code and the second transaction item ID number from the market venue. The system verifies matches to existing data elements in the open bonus store credit file. If the appropriate fields do match, the system automatically generates a confirmation email to both buyer and seller indicating that the bonus store credit is valid and can be applied to the second purchase. The system then places a hold on the open credit by updating the store credit database file. The hold prevents a re-issuing of the open credit for any other transaction between the buyer and seller.

If the data elements received by the buyer do not match, the system automatically generates an ‘invalid’ email to the buyer and seller indicating that the bonus store credit request is missing information or is invalid and should not be used as a cash equivalent in the second transaction.

If the buyer fails to apply their open bonus store credit to a second purchase before the specified expiration time of the bonus store credit, the system will automatically invalidate the open bonus store credit and the system will cease notifying the buyer of any opportunities to use the bonus store credit with the seller.

### BRIEF DESCRIPTION OF THE DRAWINGS

These and other features and advantages of the invention will now be described with reference to the drawings of certain preferred embodiments, which are intended to illustrate and not to limit the invention, and in which:

FIGS. 1A and 1B are high-level architectural drawings illustrating the primary components of a bonus store credit system that operates in accordance with the present invention.

FIG. 2 is a high-level flow diagram illustrating a method in accordance with the invention.

FIG. 3 is a high-level architectural drawing of a registration program.

FIGS. 4a-4e are screen displays of online user input forms of the registration program illustrated in FIG. 3.

FIG. 5 is a screen display depicting the displayed instructions as they would appear on the seller's closed web selling page on a market venue.

FIG. 6 is a screen display of an end-of-auction email forwarded by the seller to the bonus store credit system.

FIG. 7 is a block flow diagram illustrating a process of determining the store credit amount.

FIG. 8 is a screen display of an exemplary first email sent by the system to the buyer.

FIG. 9 is a block flow diagram illustrating the composition and sending of additional buyer emails.

FIG. 10 is an exemplary update email sent periodically by the system to the buyer.

FIG. 11 is an exemplary manual notification email received from the buyer.

FIG. 12 is an exemplary validation email sent by the system to the buyer and seller after notification of second transaction.

### DETAILED DESCRIPTION OF THE DRAWINGS

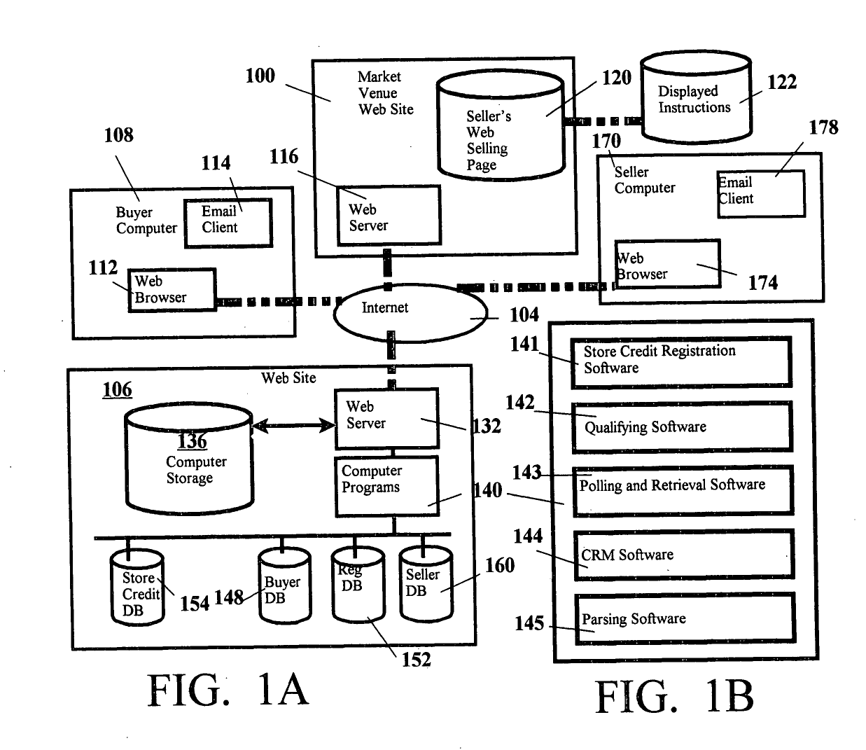

FIG. 1A illustrates the general architecture of a bonus store credit system that operates in accordance with an embodiment of the present invention. The bonus store credit system includes a buyer computer 108, a market venue web site 100, a seller computer 170 and a bonus store credit web site 106, all of which are linked together by the Internet 104.

The buyer computer 108 may be any type of computing device that allows the buyer to receive and respond to emails via email client 114 and to interactively browse web sites via a web browser 112. Web-based email may also be accessed via web browser 112. For example, the buyer computer 108 may be a personal computer (PC) that runs the Windows NT™ operating system and Netscape Navigator™, and which can access the Yahoo Mail email service at Yahoo.com.

A preferred embodiment of this invention is a system and method for use with the Internet 104. This invention is, however, not limited to the Internet. Thus, as used herein, the term “network” refers to any distributed computer network whether it be, for example, a local area network (LAN), a wide area network (WAN), or an Intranet.

The market venue web site 100 provides various functionality for allowing sellers to post products for sale and for buyers to make offers to purchase said products via a highest bid or a fixed price buying offer over the Internet using their Web browser. Market venue web site 100 may include a web server 116 hosting a seller's web selling page 120, which may include displayed instructions 122. Typically, the market venue web site 100 will be operated by a business entity (such as eBay.com, amazon.com, etc) that handles marketing functions to attract both buyer and seller to its site. The market venue web site 100 handles technical tasks to facilitate posting products for sale, subsequent transaction processing and reporting associated with the sale of goods or services between a buyer and seller. The market venue web site 100 sends information over the internet 104 through web page displays and emails to both the buyer computer 108 and the seller computer 170 so the buyer and seller receive appropriate product and transaction information to execute a product or service sale.

The bonus store credit web site server 106 advantageously includes a web server 132, data storage 136, multiple databases and multiple computer software programs 140. The databases may include a buyer database 148, a seller database 160, a registration database 152 and store credit database 154, and as shown in FIG. 1B, the software programs 140 may include store credit registration software 141, qualifying software 142, polling and retrieval software 143, CRM (Customer Relationship Management) software 144 and parsing software 145. Computer data storage 136 stores the following HTML documents:

1. Registration Image

2. Displayed Instructions

3. Buyer Portal

4. Seller Portal

5. Hosted universal store credit offer images

The seller computer 170 may be any type of computing device that allows the seller to receive and respond to emails, such as via email client 178 or via the Worldwide Web, and to interactively browse web sites via a web browser 174. For example, the seller computer 170 may be a personal computer (PC) that runs the Windows 2000™ operating system, in turn running Internet Explorer™ and Lotus Notes™ email software.

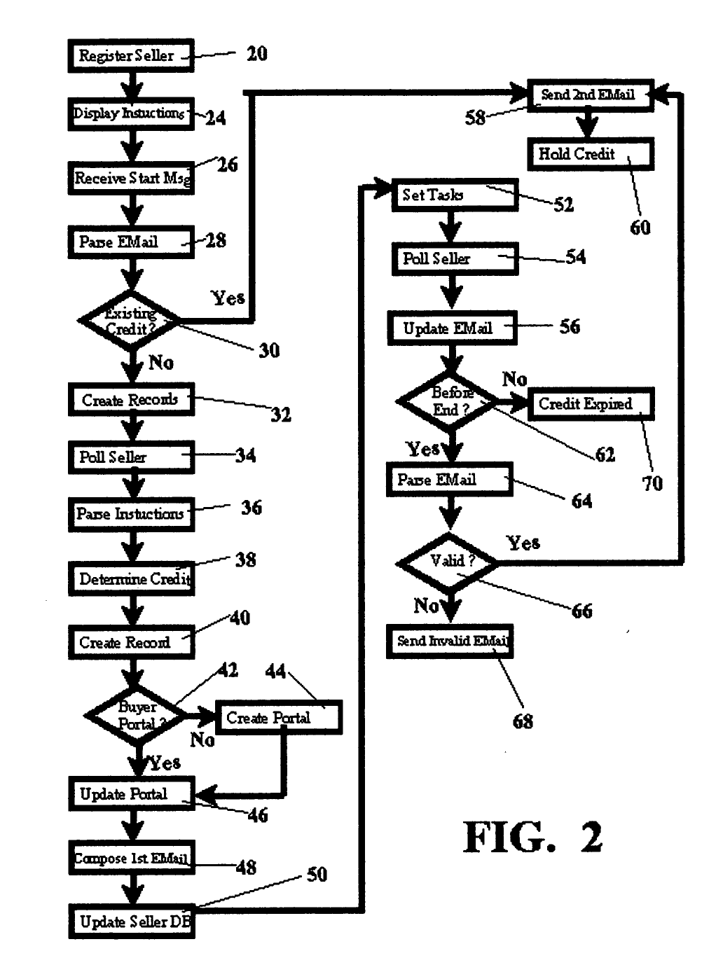

FIG. 2 is a general flow diagram of a preferred method according to the invention. Referring to this figure, the bonus store credit system provides sellers with a mechanism to register for the bonus store credit program. This process begins with seller registration in step 20, then instructions are displayed in step 24, a start message is received in step 26 and an email is parsed in step 28. In step 30 it is determined whether seller/buyer open credit already exists. If so, the method proceeds to step 58, and a second sale valid email is composed and sent. If not, then the method proceeds to step 32, and records are created. Then, in step 34 the selling page is polled and displayed instructions are retrieved. In step 36 the displayed instructions are parsed, in step 38 a bonus store credit amount is determined, and in step 40 a store credit record is created. In step 42 it is determined whether the buyer has a portal page. If not, then one is created in step 44, and the method then proceeds to step 46, otherwise the method proceeds directly to step 46. In step 46 the portal page is updated, then in step 48 a first email is composed and in step 50 the seller database 160 is updated. Tasks are set in step 52, and then step 54 comprises polling for seller listings. In step 56 an update email is composed and executed. Next, in step 62 the system waits for to receive a manual buyer notification and determines if the buyer's store credit has expired. If no manual buyer notification is received before the end expiration date of the open store credit, the store credit record is updated as expired in step 70. If a manual notification from the buyer requesting the store credit be applied is received, then the method proceeds with step 64, receiving and parsing an email request. Then, in step 66, validity of the second transaction is checked. If valid, the method proceeds to step 58, and a second sale valid email is composed and sent. After step 58, a hold is placed on the open store credit in step 60. If the result of step 66 is invalid, then in step 68 an invalid email is sent to the buyer.

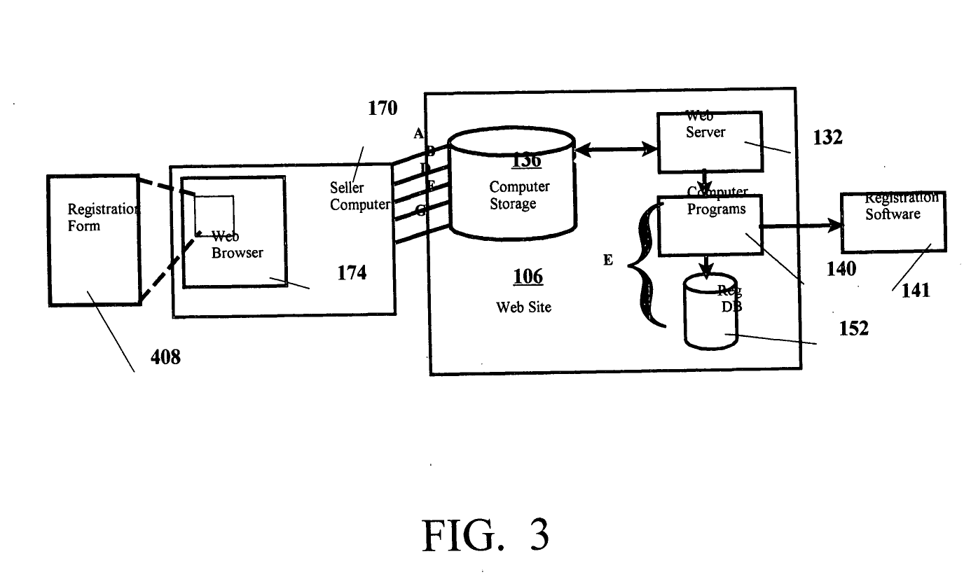

The online seller registration step, i.e. step 20, is further illustrated using an architectural drawing in FIG. 3. The system allows for a seller to access an online form 408 which is sent to the seller computer 170 for viewing by the seller browser 174. Seller computer interacts with bonus store credit web site 106 by way of events A-G, which are as follows:

A. HTTP GET DOC from server

B. HTML document sent from seller browser 174

C. Client inputs data online

D. HTTP posts data from registration form 408

E. Web server receives data; Program registration software 141 processes information creating a program registration database entry

F. Registration software 141 automatically creates displayed instructions as an HTML document to seller browser 174

G. Seller returns to program registration to make changes by HTTP GET DOC from server

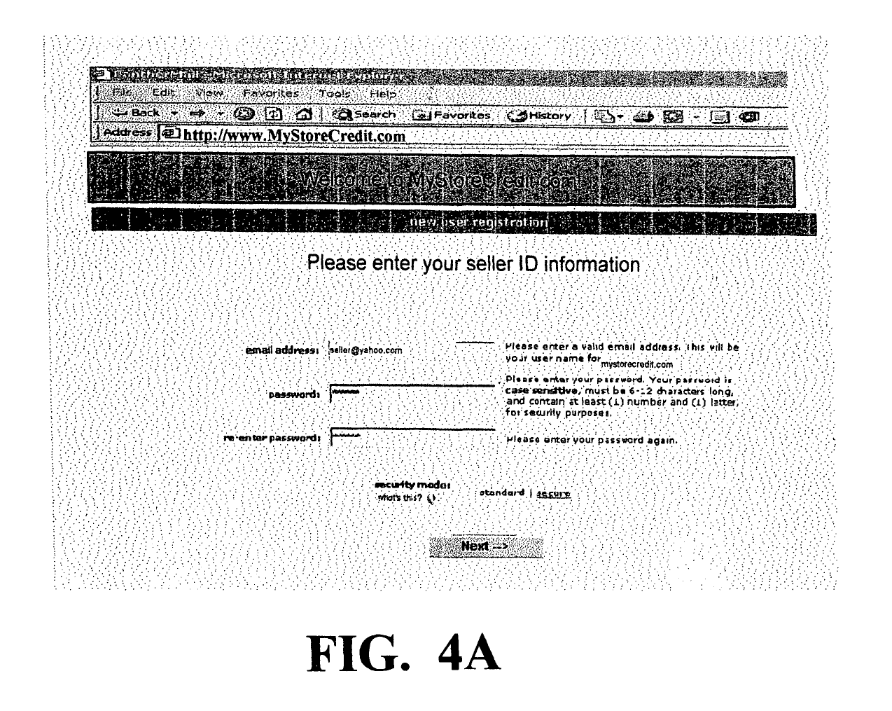

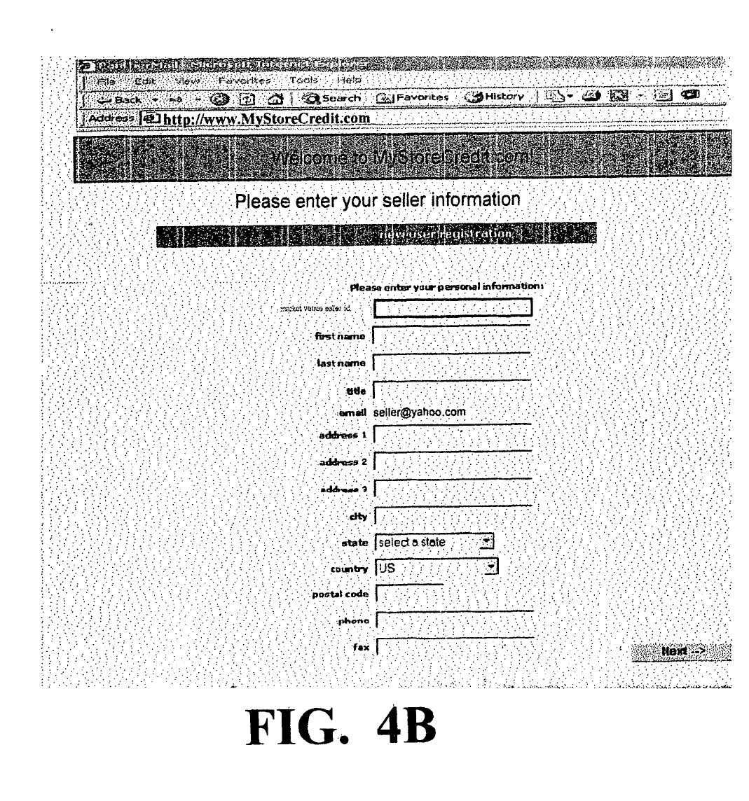

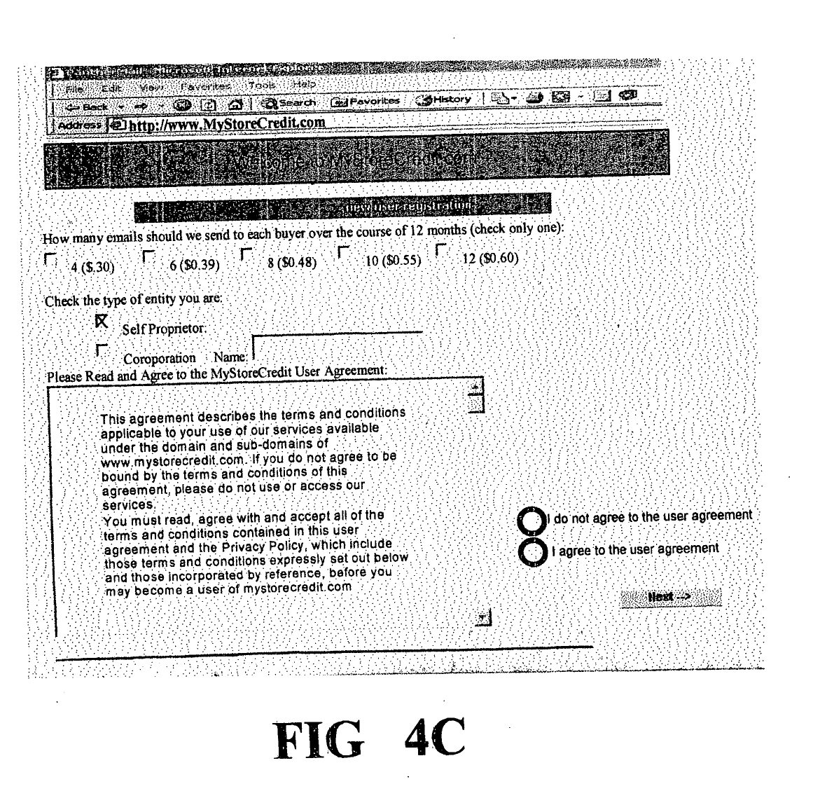

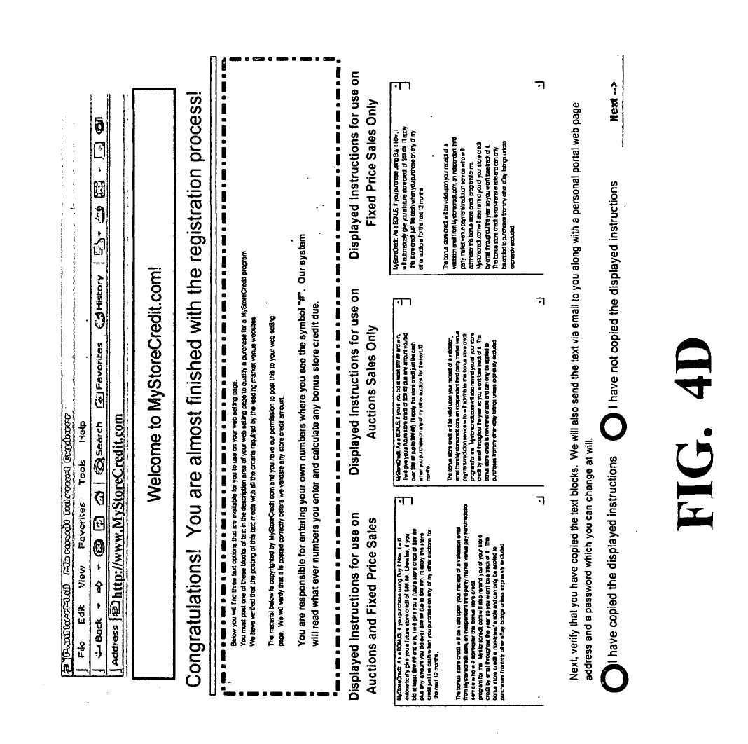

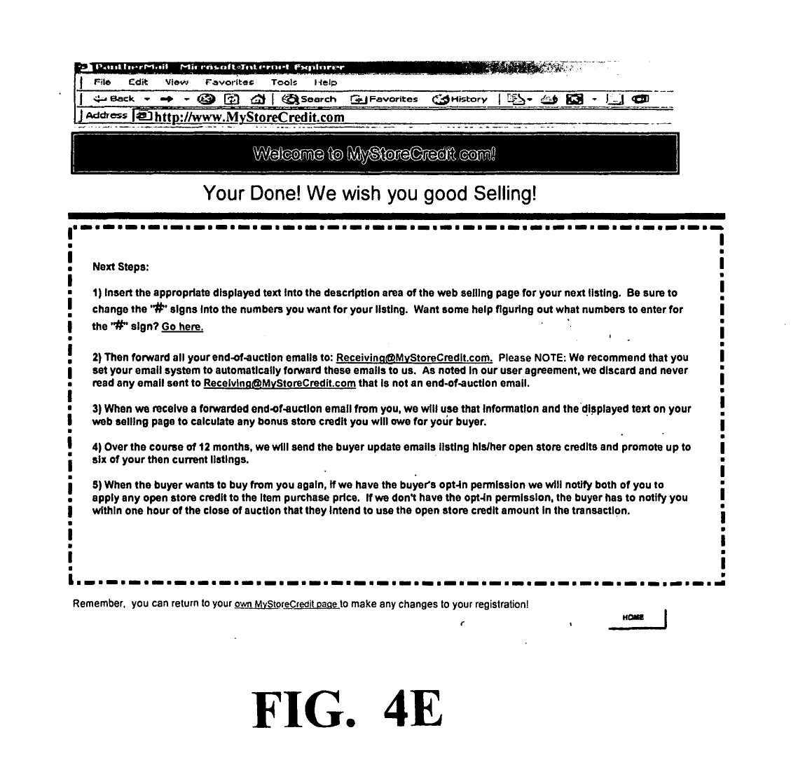

A preferred embodiment of the bonus store credit registration form 408 is illustrated in FIGS. 4A-E. The seller receives the form 408 (event B) and inputs data interacting with the form through a series of questions (event C). Once complete, the seller posts the message back (event D) to the bonus store credit web server 132. The bonus store credit web server receives the message and form and creates a program registration database entry based on the seller's user name B. The bonus store credit registration software 141 automatically displays a web page back to the seller computer 170 with confirmation of entries and instructions to be followed by the seller to appropriately update the seller's web selling page 120 to fully disclose the bonus store credit program to the buyer (event F). During the registration process, or anytime thereafter, the seller can return (event C) to the bonus store credit web site 106 and modify the program registration database entry tied to the seller's user ID.

Next, the seller promotes the bonus store credit program to potential buyers by displaying the instructions, hereinafter referred to as the displayed instructions, as indicated to the seller at the conclusion of the registration process, step 24 (see FIG. 4d). The seller posts these displayed instructions to explain the bonus store credit offer within the description area on the seller's web selling page 120 on the market venue web site 100.

The seller presents the displayed instructions 122 from the HTML documents 136 relayed to the seller computer 170 during step 24 by entering the displayed instructions during the creation of the web selling page 120 at the market venue web site 100 or by having the buyer's unique universal store credit image called to the selling page 120 from the computer storage 136. Thus, when a buyer using a web browser 112 accesses the seller's web selling page 120 from the market venue web site web server 116, the bonus store credit offer will be displayed so the buyer receives full disclosure on the bonus store credit program before choosing to purchase.

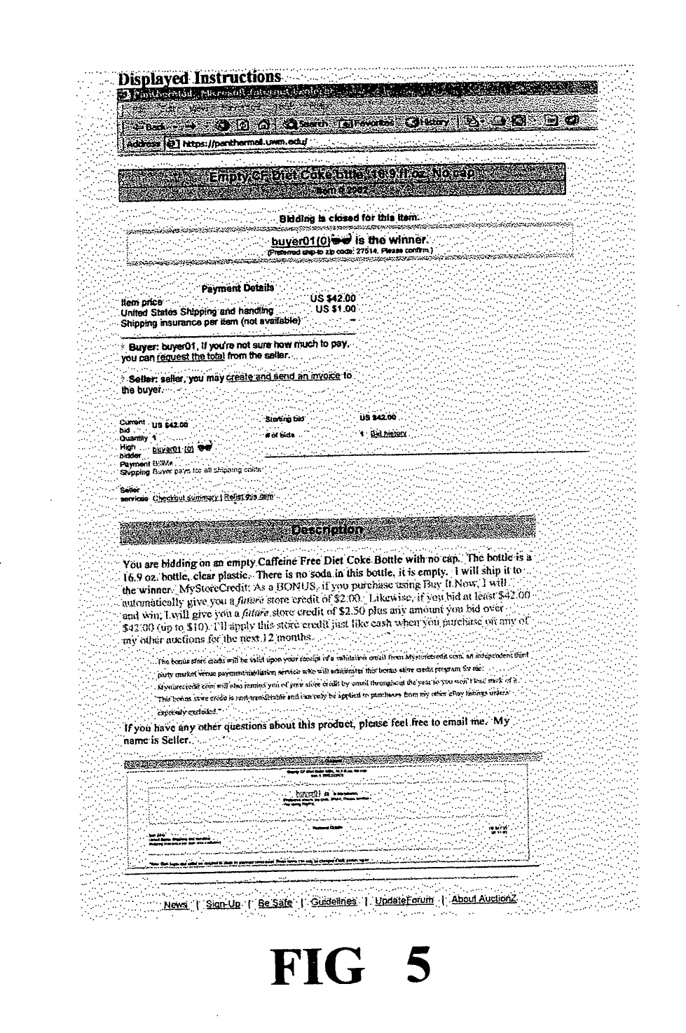

FIG. 5 illustrates how a seller would present the displayed instructions under the description title on the seller's web selling page 120 within the market venue web site 100. Those skilled in the art will recognize that the preferred embodiment has a significant advantage since it rewards the buyer with a bonus store credit only if the buyer completes a purchase with the seller.

Once the buyer makes a purchase at a fixed price or the buyer wins an auction at the market venue web site 100, the market venue web site 100 sends an end-of-auction email to the seller indicating the title of the closed listing, the item number, the seller's ID, the seller's email address, the buyer's ID, the buyer's email address, the form of the transaction (fixed price or auction), the item price and the web address of the item listing.

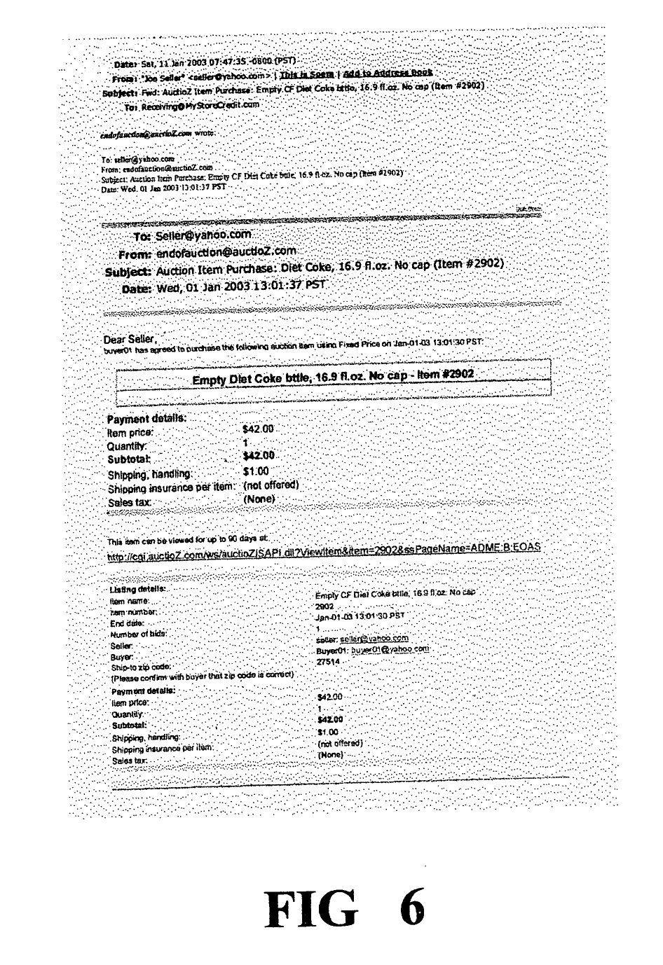

In the preferred embodiment, the seller causes the forwarding of this email to the bonus store credit web site 106 using the seller's email system 178 or instructs the market venue site 100 to send copies of this email to the bonus store credit web site 106. This forwarded email is represented in FIG. 6.

The bonus store credit web site 106 receives this email for handling by its CRM software 144. This CRM software can be a custom written application, or can be a commercial CRM software package like Kana Software.

This email message acts as the start message, step 26 of FIG. 2. As indicated, it includes relevant transaction information pertinent to the bonus store credit system. A sample start message is illustrated In FIG. 6. The start message is parsed by the CRM software 144, step 28, and the resulting information is stored appropriately in the store credit database 154. The store credit database 154, buyer database 148, registration database 152, and seller database 160 may all utilize a standard database software program such as Database2, Oracle or MySQL.

Next, the qualifying software 142 determines if there is any existing open bonus store credit amount in existence for this pair of buyer and seller to see if this transaction qualifies for existing bonus store credit (step 30). If not, a new buyer record and bonus store credit record are created (step 32) in the buyer database 148 and store credit database 154.

If an existing bonus store credit is identified in step 30, the system moves to step 58 described below.

Continuing after step 32, the system polls the seller's closed web selling page 120 and retrieves the displayed instructions 122 from the listing web address identified as the seller's web selling page 120 within the start message. This is reflected as step 34. The polling and retrieval software 143 can be implemented in the from of any number of well known types of programs, most of which are referred to as “screen scraping” programs. Such programs can be custom written or can be commercial software such as WebzInc.™ In either case, the polling and screen scraping occurs using simple instructions executed by the bonus store credit system 106. A sample of the WebzInc™ instruction code which would be executed by the polling and retrieval software 143 to perform the screen scrape function in step 34 to retrieve the relevant text from the displayed instructions on the seller's closed web selling page 120 off the market venue web site 100 follows:

MyWebParser.OpenSite

(Cgi.auctioZ.com/ws/auctioZISAPLdll?ViewItem&Item=2902&ssPageName=ADME:B:EOAS:US:3) MsgBox MyWebParser.GetTextBetweenText(“MyStoreCredit”, “excluded.”)

This simple instruction tells WebzInc's WebParser to grab the text between the first instance of the text string “MyStoreCredit” and the next instance of the text string “excluded.” Specifically, it pulls this discovered body of text from the web page address identified within the parenthesis on the first line of the instruction set following the WebzInc term “Opensite.” As used above, the address indicates the address for the closed web selling page 120 on the market venue site 100 as received in the example end-of-auction email (FIG. 6). If the universal bonus store credit offer displayed text was used, the system uses the resulting polling information to verify the presence of the buyer's unique bonus store credit offer.

Alternatively, the system can poll the market venue web site 100 directly interfacing with the market venue's listing database to retrieve the displayed instructions 122 rather than scraping the information from the closed web selling page 120. This can occur by using the market venue's approved application programming interface. Or further, the system can poll a third party intermediary who in turn polls the closed web selling page 120 to capture information from the closed web selling page and relay the data from the web selling page to the bonus store credit system.

The parsing software 145 parses the captured displayed instructions 122 into appropriate fields in the bonus store credit database 154 (step 36). The parsing software 145 parses the information which will be used to update the bonus store credit database fields with data elements used to calculate the bonus store credit.

The following text is an example of the displayed instructions 122, retrieved using a program such as WebzInc's, from the web address within the start message:

“MyStoreCredit: As a BONUS, if you purchase using Buy It Now I will to automatically give you a future store credit of $2.00. Likewise if you bid at least $42.00 and win I will give you a future store credit of $2.50 plus any amount you bid over $42.00 (up to $10). I'll apply this store credit just like cash when you purchase on any of my other auctions for the next 12 months. The bonus store credit will be valid upon your receipt of a validation email from Mystorecredit.com an independent third party market venue payment/mediation service who will administer this bonus store credit program for me. Mystorecredit.com will also remind you of your store credit by email throughout the year so you won't lose track of it. This bonus store credit is non-transferable and can only be applied to purchases from my other listings unless expressly excluded.”

Alternatively, if the seller offers the universal bonus store credit offer to a buyer, the system would verify the unique bonus store credit offer was made to the buyer and the system would create the open store credit record for the amount indicated by the seller based on the price of the buyer's winning bid. In this example, the parsing software 145 would be programmed to place the universal bonus store credit amount offered by the seller into the store credit field in the bonus store credit database 154.

If the displayed instructions 122 are not in the acceptable form as relayed to the seller during the registration process, step 20 (see FIG. 3 Event F) or the expected universal bonus store credit offer displayed instructions 122 do not exist when the system attempts to retrieve them at the closed web selling page 120, the system will still continue with step 30 to use the transaction data parsed from the start message to determine if there is any existing open bonus store credit on record for this buyer-seller combination. If so, the system moves to step 58 which is described below.

In this example, the parsing software 145 would be programmed to place the “$2.00” figure into the fixed price credit amount field in the bonus store credit database 154. Likewise, it would place “$42.00” into the minimum winning bid field in the bonus store credit database. It would further parse the “$2.50” figure referenced as the minimum bonus store credit due in an auction sale, Into a field labeled auction base credit. It would next parse the number “12” next to the word “months” into the credit expires after x months field in the bonus store credit database. It would place the $10.00 figure into the maximum rebate field.

If the displayed instructions 122 are not in the acceptable form as relayed to the seller during the registration process, step 20 (see FIG. 3 Event F) or the expected displayed instructions 122 do not exist when the system attempts to retrieve them at the closed web selling page 120, the system will still continue with step 30 to use the transaction data parsed from the start message to determine if there is any existing open bonus store credit on record for this buyer-seller combination. If so, the system moves to step 58 which is described below.

After the parsing of the displayed instructions 122, step 36, the system next moves to step 38 to determine any bonus store credit amount due the buyer.

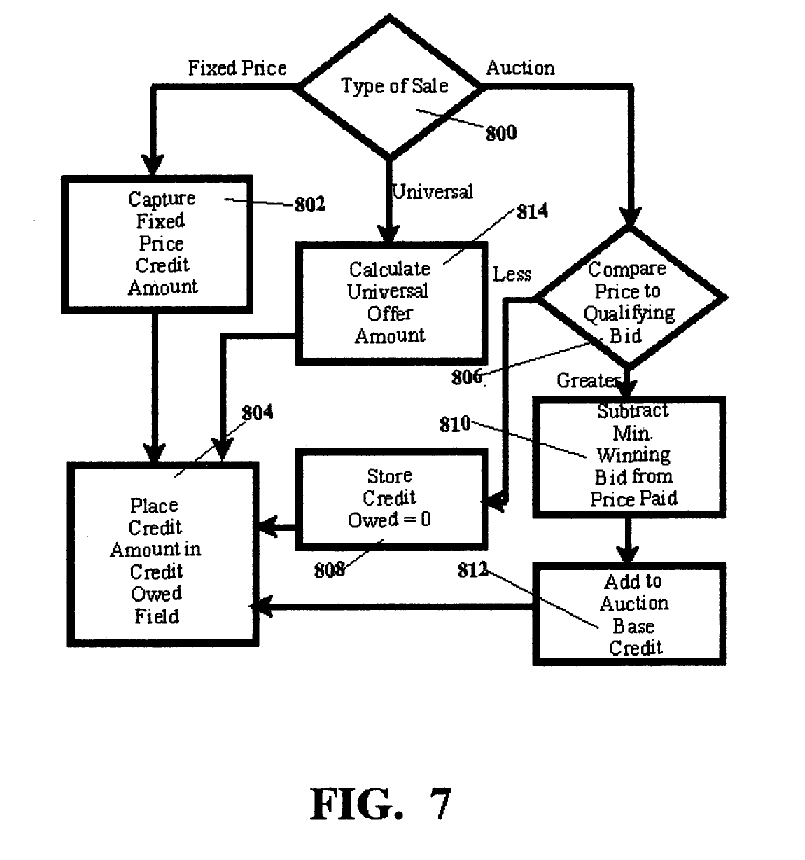

Determining the bonus store credit, step 38, is further illustrated using a block flow diagram FIG. 7. As identified as step 800, the system would first evaluate a database query to determine the purchase method, either fixed price or auction, as parsed from the start message (FIG. 6).

If fixed price was identified as the purchase method, a continuing database evaluation would access the contents of the field labeled “fixed price credit amount,” step 802, and place that figure Into the “bonus store credit owed” field, step 804 so the system can recognize that amount as the open bonus store credit amount due the buyer.

If the database query determines an auction was used as the purchase method, it would compare the figure m the “final price paid” field to the “minimum winning bid to qualify” field In the bonus store credit database, step 806. If the final price paid was less than the figure In the “minimum winning bid” field, the system would determine the store credit due is zero, step 808, and place a figure of zero into the “bonus store credit owed” field, step 804 and cease operation.

If the final price paid was greater than the “minimum winning bid” field, the database software would determine the bonus store credit owed by subtracting the figure in the “minimum winning bid” field from the figure in the “final price paid” field, and comparing the result with the value in the “maximum rebate” field, step 810. Next, the system would add that result to the amount resident in the “auction base credit” field, step 812. That total would then be placed Into the “bonus store credit owed” field of the bonus store credit database, step 804.

If the universal bonus store credit displayed text was used by the seller in the transaction, a continuing database evaluation would determine the amount of the buyer's pre-existing universal bonus store credit offer for the appropriate final winning bid amount, step 814, and place that figure Into the “bonus store credit owed” field, step 804 so the system can recognize that amount as the open bonus store credit amount due the buyer.

Upon completion of the determination of the bonus store credit amount (step 38), the system creates a bonus store credit code unique to this combination of buyer and seller email addresses and auction ID number, step 40. This unique code is hereafter referred to as the unique MyStoreCredit program code.

Next the system determines if the buyer already has access to a personal web portal page at the bonus store credit web site 106 from any prior transactions, step 42.

If not, the system creates a personal portal page for access by the buyer at the bonus store credit web site, step 44, using the CRM software 144. The system next updates the personal portal page with the new bonus store credit information, step 46. The portal page can be created within the bonus credit store system 106, for example by the use of custom written programming code instructions or through the use of a commercial CRM software package such as Kana Software. If the buyer already has a personal portal page available on the system, the system moves to step 46 and updates the personal portal page.

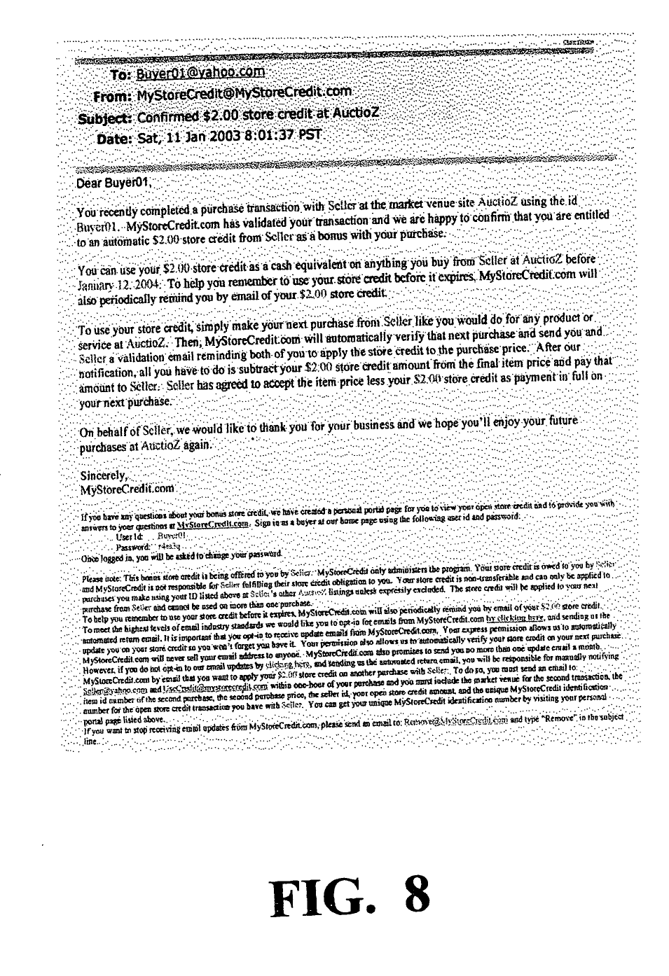

The system next composes and sends an email to the buyer which includes relevant data regarding the initiated bonus store credit program. The email is automatically composed by the CRM software 144 by pulling together pre-built templates of text combined with existing data elements from the bonus store credit database 154. A sample first email to the buyer is Included as FIG. 8. The first email composition and execution is represented as step 48 in FIG. 2.

The system regularly updates the seller database 160 with information regarding the seller specific bonus store credit programs. The system uses this data to update a personal portal page for the seller and to generate and then email periodic summary reports to the seller on the seller's bonus store credit programs, step 50. The personal buyer portal page can be created within the bonus store credit system 106, for example by use of custom written programming code instructions, or through the use of a commercial CRM software package such as Kana Software.

The CRM software 144 next sets a task list relative to the unique MyStoreCredit record, step 52, based on information entered into the bonus store credit database 154. For instance, the CRM software 144 identifies the number in the “credit expires after x months” database field, and divides that by the number of emails the seller wishes to send the buyer over the course of the bonus store credit valid period. The seller previously entered the number of emails during the registration, step 20 (see FIG. 4C) or a default number of emails, for example 12, is used.

The seller's answer is stored as the “frequency of email” number in the program registration database 152. The “frequency of email” number is overlaid by the CRM software 144 on an annual calendar to determine specific dates when update emails should be delivered to the buyer. For example, if the seller chooses to send 12 emails over a 12 month period, the CRM software 144 calculates the dates the emails should be sent for each of the next twelve months. Alternatively, if the seller chooses to send 4 emails over a 12 month bonus store credit valid period, the CRM software 144 would calculate the dates the emails should be sent, once each during the next four quarters.

The polling task is represented by step 54, and is executed by the polling and retrieval software 143 immediately prior to the sending of an update email to the buyer. The polling and retrieval software 143 polls the market venue web site 100 to identify and capture all currently available listings being run by the seller. The polling and retrieval may be implemented by any number of well-known programs, most of which are of the type referred to as “screen scraping” programs. Such programs can be custom written or can be commercial software such as WebzInc™ as indicated in an earlier step. The titles of the seller's listings and the listing's related web addresses are captured during the polling and placed into the seller database 160. Alternatively, the system can use the market venue's application programming interface in lieu of the screen scraping option.

At the appropriate delivery time, the CRM software 144 composes the additional buyer update emails by pulling information from various databases, step 56.

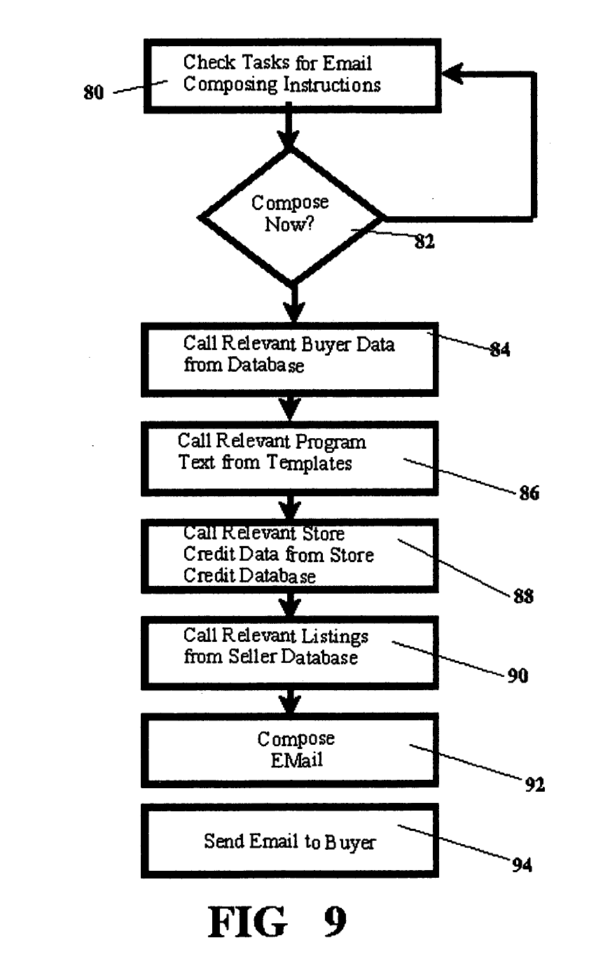

FIG. 9, is a block flow diagram on the composition and execution of additional buyer emails.

Referring to FIG. 9, the CRM software program 144 checks the task list for email composing Instructions, step 80. If, during step 82, the CRM software 144 determines that it is not time to compose emails, it returns to step 80. If the time is appropriate to compose the emails, the CRM software moves to step 84, and captures relevant buyer data from the buyer database 154. This information will Include the buyer's email address and seller's ID. The CRM software 144 also pulls standard pre-written templates regarding the purpose of the email and standard language explaining the program from within the CRM software program 144, step 86. The email program will also pull the expiration date, market venue, and current “bonus store credit owed” figure from the bonus store credit database 154, Step 88. Additionally, the CRM software 144 pulls in the relevant active seller listing titles captured during step 54 (FIG. 2) and their associated web address, known as the seller's listings, from the seller database 160, step 90.

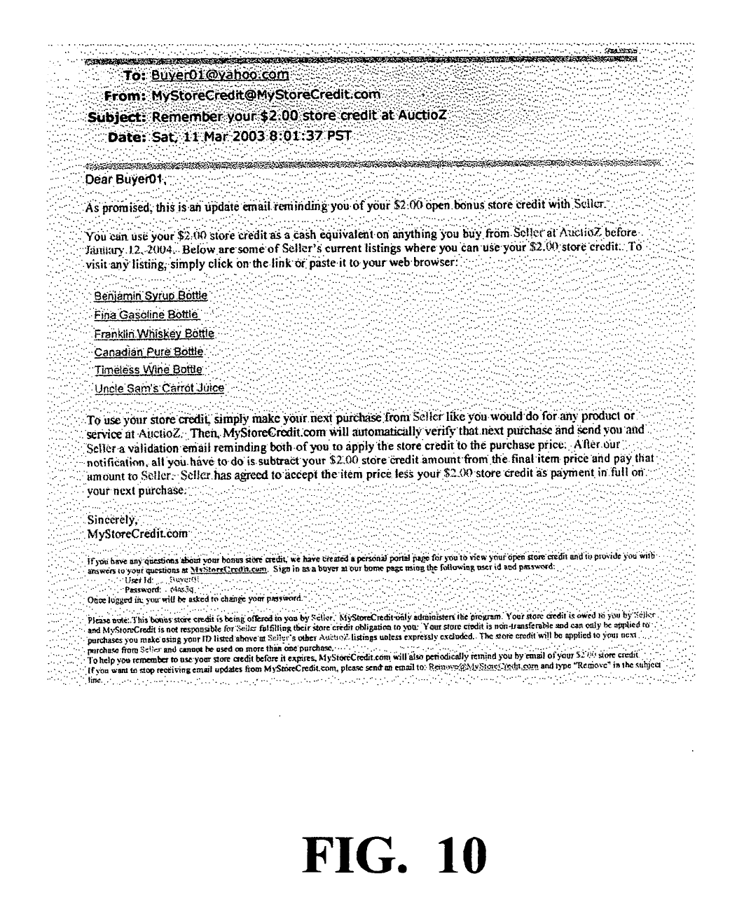

Next, the CRM software 144 composes these various elements Into an email, step 92, and sends the email to the buyer's email address, step 94. FIG. 10 is an example of an update email sent to the buyer.

The seller listings Included in the email are composed as HTML links.

Any time before the expiration date of the bonus store credit, the buyer can use the open bonus store credit as a cash equivalent In a second purchase with the seller. The displayed instruction 122, is an expressed agreement between the seller and buyer to use the bonus store credit as a cash equivalent for any subsequent purchase made by the buyer from the seller's web selling page 120.

Thus, when a buyer subsequently chooses to again purchase from the seller through either a fixed price option or through successful bidding on the sellers web selling page 120 at the market venue web site 100, hereafter refereed to as a second transaction, the system is designed to validate the availability of the bonus store credit amount for use In the second transaction.

When the buyer concludes a second purchase from the seller using either a fixed price process or winning bid, the seller forwards the end-of-auction email (FIG. 5) for receipt by the CRM software 144, as a start message (step 26).

If, the system recognizes that the second transaction is subsequently identified as matching an existing buyer/seller open credit (step 30), the system next moves to step 58, where the CRM software 144 is called to compose and send an email validating the bonus store credit amount which should be deducted from the item price indicated in the second end-of-auction email received.

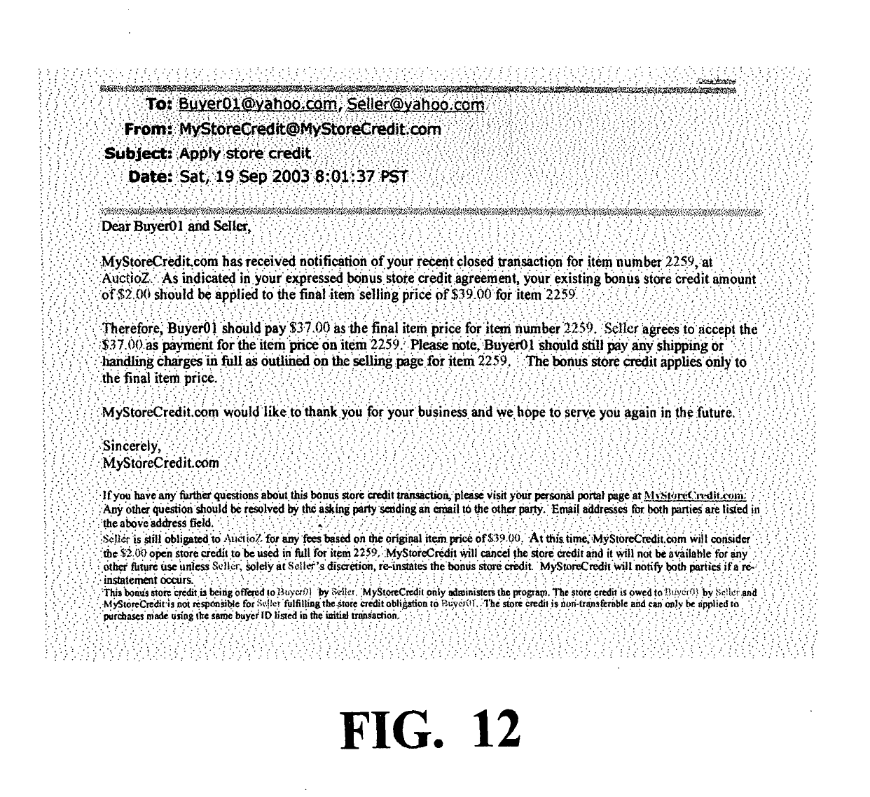

FIG. 12 is a sample validation email sent by the system to the buyer and seller validating the availability of the open store credit amount for use in the second transaction.

The validation email is composed by the CRM software 144 with elements pulled from the bonus store credit database 154 from the second end-of-auction email and from standard text residing within the CRM software 144. The buyer and seller receive this validation email as soon as possible following receipt of the start message.

After sending the validation email, the system places a “hold” indicator on the open bonus store credit, step 60, by updating the bonus store credit database 154. This hold prevents a re-validation of the open bonus store credit for any other transaction between the buyer and seller. The seller is expected to periodically return to the bonus store credit site to close out all held bonus store credits.

Alternatively, a buyer can manually notify˜the seller and the bonus store credit system 106 via email that the buyer wishes to apply the open bonus store credit as a cash equivalent payment to a second purchase before the end of the valid term of the open store credit (step 62). The system receives the email by the CRM software 144, and the parsing software 145 parses the buyer's email into individual data elements, step 64.

For example, the parsing software 144, parses the buyer's email address, the date and time of the email, the indicated bonus store credit amount, the sellers' email address and the unique MyStoreCredit code.

The system next validates that these elements are valid by matching the existing data elements In the bonus store credit database 154 against the elements parsed, step 66. If they do match, the CRM software 144 automatically generates a validation email to both buyer and seller (step 58) indicating that the bonus store credit is valid and can be applied to the second purchase as instructed by the buyer.

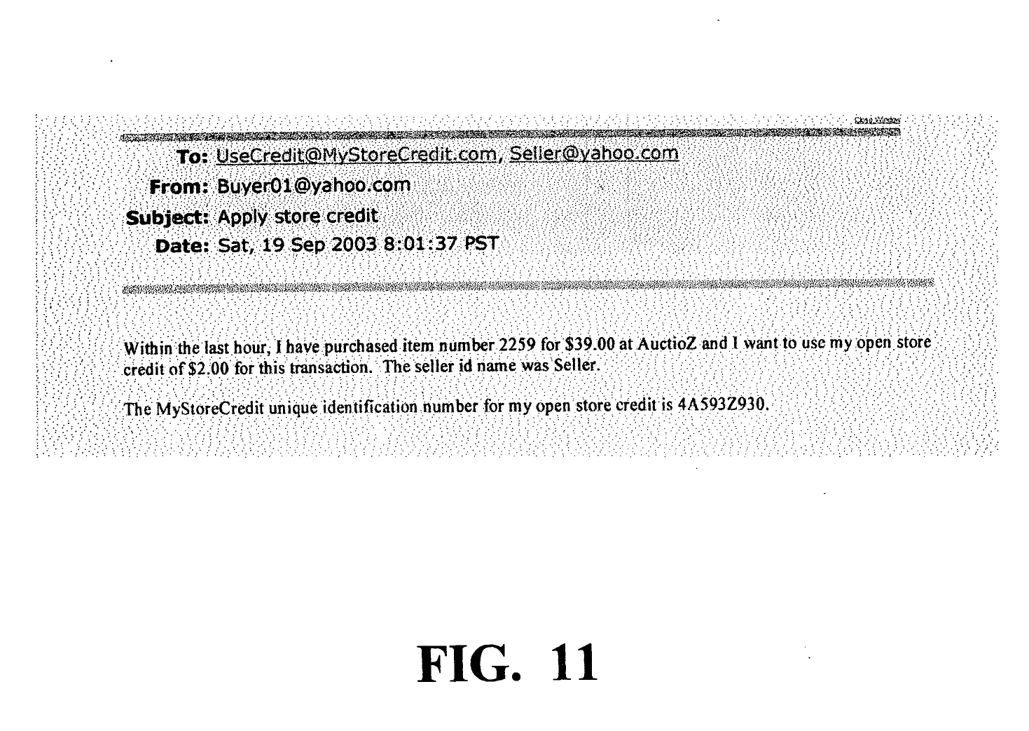

FIG. 11 is a sample validation email sent by the system to the buyer and seller validating the availability of the open store credit amount for use in the second transaction.

If the data elements do not match the system automatically generates an invalid email to the buyer Indicating that the bonus store credit application is invalid, step 68.

Subsequent to the first purchase, if the system does not identify an existing seller buyer second transaction, step 30, nor does it receive a buyer request for use of the bonus store credit, step 62, the system moves to step 70 at the end of the valid time period for the open store credit and updates the open store credit database 154 as expired.

It will be appreciated by those skilled in the art that numerous modifications and variations are possible, and that the invention may be practiced otherwise than as specifically described herein, without departing from the scope thereof.

What is claimed is:

1. A bonus store credit web site for facilitating a bonus store credit program involving a seller computer and a buyer computer connected via a network to a market venue, said bonus store credit web site configured to:
(a) implement a process for said seller computer to propose a bonus store credit to said buyer computer by means of a displayed instruction on a selling page at said market venue,
(b) determine a bonus store credit amount by applying said displayed instruction to a first transaction completed by said buyer computer and said seller computer at said market venue,
(c) validate said bonus store credit amount to said buyer computer by sending at least one message to said buyer,
said buyer automatically receiving a notification of said bonus store credit amount if said buyer's first transaction with said seller satisfies requirements outlined in said displayed instructions.

2. The bonus store credit web site of claim 1, wherein:
said bonus store credit web site validates an availability of said bonus store credit amount for use in a second transaction by said buyer computer and said seller computer by identifying a buyer computer's completed said second transaction from said seller computer.

3. The bonus store credit web site of claim 2, wherein:
said bonus store credit web site notifies said buyer computer and said seller computer in at least one message of said bonus store credit amount following said second transaction.

4. The bonus store credit web site of claim 1, wherein:
said bonus store credit web site polls said market venue for at least one open seller listing by means of a software polling process.

5. The bonus store credit web site of claim 4, wherein;
said bonus store credit web site relays said bonus store credit amount with any discovered open seller listings to said buyer computer by at least one message.

6. The bonus store credit web site of claim 1, wherein:
said bonus store credit web site receives notification by means of a message from said buyer computer indicating an exercise of said bonus store credit amount in a second transaction with said seller computer.

7. The bonus store credit web site of claim 6, wherein:
said bonus store credit web site notifies said buyer computer and said seller computer in at least one message of a validity of said bonus store credit amount following said second transaction.

8. The bonus store credit web site of claim 1, wherein:
said network is the Internet.

9. The bonus store credit web site of claim 1, wherein:
said at least one message is sent by electronic mail.

10. An automated method, performed by a computer-based bonus store credit system, for implementing, determining and validating a bonus store credit program between a seller computer and a buyer computer as part of a transaction at a market venue, the method comprising:
implementing a process for said seller computer to propose a bonus store credit program to said seller computer through displayed information on said seller's selling web page at said market venue;
determining a bonus store credit amount by applying said displayed instructions to a first transaction completed by said buyer computer and said seller computer at said market venue;
validating said bonus store credit amount to said buyer by sending at least one message to said buyer computer.

11. The method of claim 10, further comprising:
validating an availability of said bonus store credit amount for use in a second transaction by said buyer and said seller computer based on an identification of said buyer's said second transaction with said seller computer.

12. The method of claim 11, further comprising:
notifying said buyer computer and said seller computer of said bonus store credit amount in at least one message following said second transaction.

13. The method of claim 10, further comprising:
searching said market venue for at least one open seller listing.

14. The method of claim 13, further comprising:
relaying to said buyer computer said open bonus store credit amount with any discovered additional seller listing in a message.

15. The method of claim 10, further comprising:
notifying said bonus store credit web site of an exercise of said bonus store credit amount in a second transaction in at least one message from said buyer computer.

16. The method of claim 15, further comprising:
notifying said buyer computer and said seller computer of a validity of said bonus store credit amount following said second transaction in at least one message.

17. The method of claim 10, wherein:
said network is the Internet.

18. The method of claim 10, wherein:
said at least one message is sent by electronic mail.

19. A store credit management subsystem for use in conjunction with a network base market venue, said store credit management subsystem comprising at least one computer comprising software, wherein:
said at least one computer is configured by said software to:
obtain information as to a first winning bid or buy order by a buyer, for a first product offered by a seller at said network based market venue;
input information as to terms of a bonus offered with said first product;
determine a bonus amount based on said information as to terms of said bonus and said information as to said first winning bid;
update a database of said store credit management subsystem to reflect said bonus amount.

20. The store credit management subsystem according to claim 19, wherein:
said at least one computer is configured to transmit a message including said bonus amount to at least one device selected from the group consisting of a buyer device and a seller device.

21. The store credit management subsystem according to claim 20, wherein:
said at least one computer is configured to transmit said message via electronic mail.

22. The store credit management subsystem according to claim 20, wherein:
said at least one computer is configured to transmit said message via hypertext transfer protocol.

23. The store credit management subsystem according to claim 19, wherein:
said at least one computer is configured to transmit a message including a reminder of said bonus offered with said first product along with an identification of said seller.

24. The store credit management subsystem according to claim 19, wherein said at least one computer is configured to:
after updating said database, check the network based market venue for one or more additional products or services for sale by the seller; and
in a case that at least one additional product for sale by said seller is found at said network based market venue;
generate a message comprising a reminder of said bonus offered with said first product, and an identification of at least a subset of said at least one additional product for sale by said seller.

25. The store credit management subsystem according to claim 19, wherein:
in inputting information as to terms of said bonus offered with said product, said at least one computer is configured to capture a description of said terms from said network based market venue.

26. The store credit management subsystem according to claim 19, wherein said at least one computer is configured to:
after obtaining information of said first winning bid or buy order by said buyer, for said first product offered by said seller at said network based market venue, obtain information of a second winning bid or buy order by said buyer, for a second product offered by said seller st said network based market venue; and
check said data base to ascertain said bonus amount.

27. The store credit management subsystem according to claim 26, wherein:
said at least one computer is configured to transmit a message about said bonus to at least one device selected from the group consisting of a buyer device and a seller device.

28. The store credit management subsystem according to claim 26, wherein:
said at least one computer is configured to transmit in conjunction with said message about said bonus at least one message relating to a closing of a second transaction to at least one device selected from the group consisting of a buyer device and a seller device.

29. The store credit management subsystem according to claim 19, wherein:
said at least one computer is configured to transmit a message referencing said second product, and including said bonus amount to at least one device selected from the group consisting of a buyer device and a seller device.

30. The store credit management subsystem according to claim 29, wherein:
said at least one computer is configured to transmit in conjunction with said message referencing said second product at least one message relating to a closing of a second transaction to at least one device selected from the group consisting of a buyer device and a seller device.
